(19) United States
(12) Patent Application Publication
(10) Pub. No.: US 2025/0209813 A1
(43) Pub. Date: Jun. 26, 2025

(54) ENHANCED MONITORING METHOD FOR AGRICULTURAL PLANTING BASED ON UAV REMOTE SENSING

(71) Applicant: Zhejiang University, Hangzhou City (CN)

(72) Inventors: Pengcheng NIE, Hangzhou City (CN); Peishuai LI, Hangzhou City (CN); Baoyun ZHANG, Hangzhou City (CN); Xiangwei PENG, Hangzhou City (CN); Wenna ZHANG, Hangzhou City (CN); Yong HE, Hangzhou City (CN)

(21) Appl. No.: 18/999,106

(22) Filed: Dec. 23, 2024

(30) Foreign Application Priority Data
Dec. 25, 2023 (CN) 202311789414.2

(51) Int. Cl. G06V 20/10; G06V 20/17

(52) U.S. Cl. CPC G06V 20/188; G06V 20/17

(57) ABSTRACT

This application relates to the technical field of image data processing, and in particular, to an enhanced monitoring method for agricultural planting based on unmanned aerial vehicle (UAV) remote sensing. The method includes: obtaining a farmland grayscale image, from which a plurality of target pixel points are selected; next, obtaining a plurality of neighborhood blocks corresponding to each target pixel point, and then obtaining a credibility of each neighborhood block corresponding to the target pixel point, thereby selecting a plurality of main neighborhood blocks corresponding to the target pixel point; and obtaining a filtering weight of each main neighborhood block corresponding to the target pixel point, thereby deriving a farmland enhanced image from the farmland grayscale image.

### CROSS REFERENCE TO RELATED APPLICATION

This patent application claims the benefit and priority of Chinese Patent Application No. 202311789414.2, filed with the China National Intellectual Property Administration on Dec. 25, 2023, the disclosure of which is incorporated by reference herein in its entirety as part of the present application.

### TECHNICAL FIELD

The present disclosure relates to the technical field of image data processing, and in particular, to an enhanced monitoring method for agricultural planting based on unmanned aerial vehicle (UAV) remote sensing.

### BACKGROUND

Monitoring planting conditions of crops using UAVs can significantly reduce labor and material costs. In the context of agricultural monitoring based on UAV remote sensing, collected images may be affected by interference from factors such as weather, resulting in the presence of noise points in the images. This can interfere with the analysis of the planting conditions of crops in the fields. Currently, non-local means filtering algorithms are commonly used to denoise and enhance the collected remote sensing images.

Existing problems: The collected remote sensing images may have noise interference, which affects the effectiveness of agricultural planting monitoring. When filtering weights in the non-local means filtering algorithm are not appropriately selected, the effect of filtering and noise reduction is poor, leading to a situation where the quality of the filtered and smoothed remote sensing images remains subpar, thereby reducing the effectiveness of agricultural planting monitoring.

### SUMMARY

The present disclosure provides an enhanced monitoring method for agricultural planting based on UAV remote sensing to address the existing problems.

The enhanced monitoring method for agricultural planting based on UAV remote sensing in the present disclosure adopts the following technical solution:

The present disclosure provides an enhanced monitoring method for agricultural planting based on UAV remote sensing, including the following steps:
acquiring a farmland grayscale image of a farmland, where the farmland grayscale image contains a plurality of edge lines; and selecting a plurality of main edge lines from all the edge lines in the farmland grayscale image;
obtaining a noise probability of each pixel point based on grayscale value differences between pixel points in the farmland grayscale image and distances from the pixel points to the main edge lines; and selecting a plurality of target pixel points based on the noise probability of each pixel point;
taking an arbitrary target pixel point in the farmland grayscale image as a target point, and obtaining a plurality of neighborhood blocks corresponding to the target point; obtaining a credibility of each neighborhood block corresponding to the target point based on all main edge lines in the neighborhood block, a connection line between the target point and the neighborhood block, and the noise probabilities of pixel points in the neighborhood block; and selecting a plurality of main neighborhood blocks corresponding to the target point based on the credibility of each neighborhood block corresponding to the target point;
obtaining a filtering weight of each main neighborhood block corresponding to the target point based on all main edge lines in the main neighborhood block, the noise probabilities of pixel points in the main neighborhood block, the credibility of the main neighborhood block, as well as a distance and a connection line between the target point and the main neighborhood block; and
obtaining an enhanced farmland image from the farmland grayscale image based on all main neighborhood blocks corresponding to all target pixel points in the farmland grayscale image and the filtering weights of all the main neighborhood blocks.

Further, said selecting a plurality of main edge lines from all the edge lines in the farmland grayscale image specifically includes:
counting the number of pixel points on each edge line in the farmland grayscale image, and designating edge lines with a pixel point count greater than a preset quantity threshold as the main edge lines.

Further, said obtaining the noise probability of each pixel point based on the grayscale value differences between the pixel points in the farmland grayscale image and the distances from the pixel points to the main edge lines specifically includes:
taking an arbitrary pixel point in the farmland grayscale image as a reference point;
calculating a minimum distance from the reference point to each main edge line in the farmland grayscale image, and designating a minimum value among the minimum distances from the reference point to all the main edge lines as an edge distance of the reference point;
in the farmland grayscale image, defining a window centered on the reference point with a size of n₁×n₁ as a main window of the reference point, wherein n₁ is a preset window length; and
obtaining a noise probability of the reference point based on grayscale values of pixel points within the main window of the reference point and the edge distance of the reference point.

Further, a specific calculation formula for obtaining the noise probability of the reference point based on the grayscale values of the pixel points within the main window of the reference point and the edge distance of the reference point is as follows:

$$M = Norm ( \frac{1}{Z + β} \times \frac{{\sum }_{i = 1}^{m} \vert G - {G}_{i} \vert}{{G}_{avg}} )$$

where M denotes the noise probability of the reference point, Z denotes the edge distance of the reference point, G_{avg} denotes an average grayscale value of all pixel points in the main window of the reference point, G denotes a grayscale value of the reference point, Gᵢ denotes a grayscale value of the i-th pixel point in the main window of the reference point, m denotes the number of pixel points in the main window of the reference point, ∥ denotes an absolute value function, Norm( ) denotes a linear normalization function, and β denotes a preset constant.

Further, said selecting a plurality of target pixel points based on the noise probability of each pixel point specifically includes:
in the farmland grayscale image, designating pixel points with a noise probability greater than a preset noise threshold as the target pixel points.

Further, said obtaining a plurality of neighborhood blocks corresponding to the target point specifically includes:
in the farmland grayscale image, performing calculation on the target point based on a preset search window size and a preset neighborhood window size by using a non-local means filtering algorithm, to obtain the plurality of neighborhood blocks corresponding to the target point.

Further, said obtaining the credibility of each neighborhood block corresponding to the target point based on all the main edge lines in the neighborhood block, the connection line between the target point and the neighborhood block, and the noise probabilities of the pixel points in the neighborhood block specifically includes:
counting the number of all pixel points on all the main edges within each neighborhood block corresponding to the target point; and performing linear fitting on all the pixel points on all the main edges using a least squares method, to obtain a fitting line for each neighborhood block corresponding to the target point;
denoting a line that passes through the target point and a center point of each neighborhood block corresponding to the target point as a position line of each neighborhood block corresponding to the target point;
recording a minimum angle value between the fitting line and the position line of each neighborhood block corresponding to the target point as a degree of parallelism of each neighborhood block corresponding to the target point; and
obtaining the credibility of each neighborhood block corresponding to the target point based on the degree of parallelism of each neighborhood block corresponding to the target point and the noise probabilities of all the pixel points within the neighborhood block, with a specific calculation formula as follows:

$${F}_{j} = Norm ( ( 1 - {M}_{j}^{′} ) \times \frac{1}{β + {B}_{j}} )$$

where Fⱼ denotes the credibility of the j-th neighborhood block corresponding to the target point, Mⱼ′ denotes a mean of the noise probabilities of all pixel points in the j-th neighborhood block corresponding to the target point, Bⱼ denotes the degree of parallelism of the j-th neighborhood block corresponding to the target point, Norm( ) denotes a linear normalization function, and β denotes a preset constant.

Further, said selecting a plurality of main neighborhood blocks corresponding to the target point based on the credibility of each neighborhood block corresponding to the target point specifically includes:
among all the neighborhood blocks corresponding to the target point, designating neighborhood blocks with a credibility greater than a preset criterion threshold as the main neighborhood blocks corresponding to the target point.

Further, a specific calculation formula for obtaining the filtering weight of each main neighborhood block corresponding to the target point based on all the main edge lines in the main neighborhood block, the noise probabilities of the pixel points in the main neighborhood block, the credibility of the main neighborhood block, as well as the distance and the connection line between the target point and the main neighborhood block is as follows:

$${Q}_{x} = ( 1 - \frac{C}{90} ) \times \frac{{F}_{x}^{′} \times ( {H}_{x} + β )}{( {M}^{′} + {M}_{x}^{″} )} \times \frac{1}{{D}_{x}}$$

where Qₓ denotes the filtering weight of the x-th main neighborhood block corresponding to the target point, C denotes a characteristic value of distribution of the main neighborhood blocks corresponding to the target point, Fₓ′ denotes the credibility of the x-th main neighborhood block corresponding to the target point, Hₓ denotes the number of pixel points on all main edge lines in the x-th main neighborhood block corresponding to the target point, M′ denotes the noise probability of the target point, Mₓ″ denotes a mean of the noise probabilities of all pixel points in the x-th main neighborhood block corresponding to the target point, Dₓ denotes a distance from the target point to a center point of the x-th main neighborhood block corresponding to the target point, and β denotes a preset constant;
a process of obtaining the characteristic value of the distribution of the main neighborhood blocks corresponding to the target point includes: denoting a minimum angle value between position lines of any two main neighborhood blocks corresponding to the target point as a position distribution value for said any two main neighborhood blocks; and
denoting a mean of position distribution values of all the main neighborhood blocks corresponding to the target point as the characteristic value of the distribution of the main neighborhood blocks corresponding to the target point.

Further, said obtaining the enhanced farmland image from the farmland grayscale image based on all the main neighborhood blocks corresponding to all the target pixel points in the farmland grayscale image and the filtering weights of all the main neighborhood blocks specifically includes:
in the farmland grayscale image, filtering and denoising the target point based on all the main neighborhood blocks corresponding to the target point and the filtering weights of all the main neighborhood blocks by using a non-local means filtering algorithm, to obtain an updated grayscale value of the target point; and
designating an image composed of updated grayscale values of all the target pixel points and grayscale values of all other pixel points except the target pixel points in the farmland grayscale image as the farmland enhanced image corresponding to the farmland grayscale image.

The technical solutions of the present disclosure have the following beneficial effects:

In the embodiments of the present disclosure, a farmland grayscale image is obtained, from which a plurality of target pixel points are selected. This reduces the computational load for subsequent pixel filtering and denoising, thereby improving the computational speed. Next, a plurality of neighborhood blocks corresponding to each target pixel point are obtained, and the credibility of each neighborhood block corresponding to the target pixel point is obtained, thereby selecting a plurality of main neighborhood blocks corresponding to the target pixel point. This reduces unreliable neighborhood blocks among the neighborhood blocks, thus enhancing the effectiveness of the subsequent filtering and denoising. The filtering weight of each main neighborhood block corresponding to the target pixel point is obtained, thereby deriving a farmland enhanced image from the farmland grayscale image. This allows for adaptive filtering weights to further improve the filtering and denoising effect, thus achieving a high-quality farmland enhanced image. In the embodiment of the present disclosure, main neighborhood blocks are selected from the neighborhood blocks corresponding to the target pixel points, and filtering weights of the main neighborhood blocks are adapted, to enhance the filtering and denoising effect, resulting in a high-quality farmland enhanced image, which ultimately enhances the monitoring effect for agricultural planting.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. Apparently, the accompanying drawings in the following description show merely some embodiments of the present disclosure, and a person of ordinary skill in the art may still derive other drawings from these accompanying drawings without creative efforts.

FIG. 1 is a flowchart of steps of an enhanced monitoring method for agricultural planting based on UAV remote sensing according to the present disclosure; and

FIG. 2 is a schematic diagram of a farmland grayscale image according to an embodiment of the present disclosure.

### DETAILED DESCRIPTION OF THE EMBODIMENTS

To further describe the adopted technical means and the effects of the present disclosure to achieve an intended purpose of the disclosure, the following describes embodiments, structural features and effects of the enhanced monitoring method for agricultural planting based on UAV remote sensing according to the present disclosure in detail with reference to the accompanying drawings and preferred embodiments. In the following description, the term “one embodiment” or “another embodiment” used in different parts do not necessarily refer to the same embodiment. In addition, the specific features, structures or characteristics in one or more embodiments may be combined in any appropriate form.

Unless otherwise defined, all technical and scientific terms used herein have the same meanings as commonly understood by those skilled in the technical field of the present disclosure.

A specific scheme of the enhanced monitoring method for agricultural planting based on UAV remote sensing provided by the present disclosure is described in detail below with reference to the accompanying drawings.

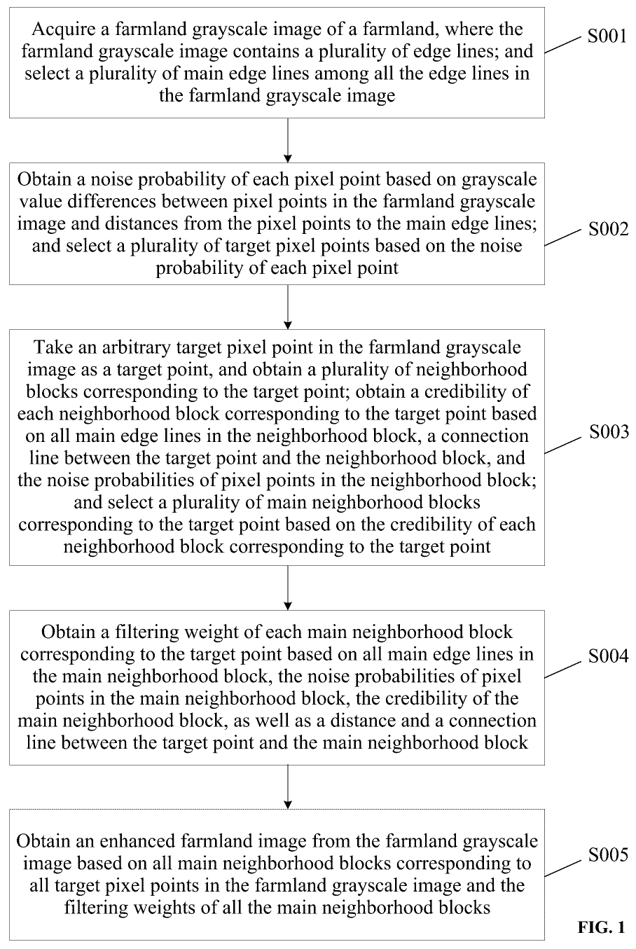

FIG. 1 is a flowchart of steps of an enhanced monitoring method for agricultural planting based on UAV remote sensing according to an embodiment of the present disclosure. The method includes the following steps:

Step S001: Acquire a farmland grayscale image of a farmland, where the farmland grayscale image contains a plurality of edge lines; and select a plurality of main edge lines among all the edge lines in the farmland grayscale image.

The primary aim of this embodiment is to improve the filtering and denoising effect by adaptively selecting filtering weights in a non-local means filtering algorithm, thereby achieving high-quality farmland enhanced images and completing enhanced monitoring for agricultural planting.

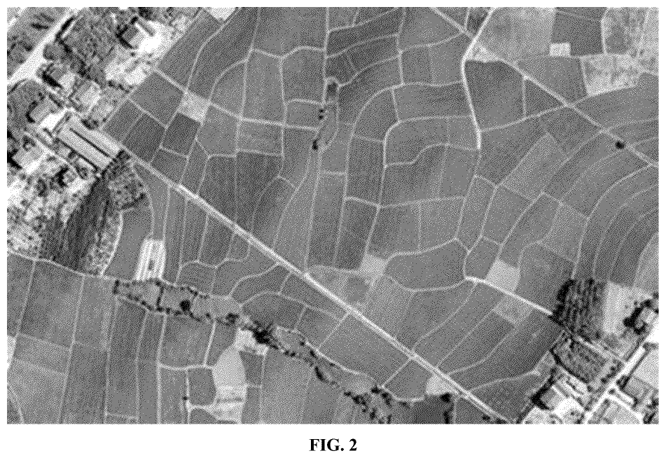

A remote sensing image of a farmland is acquired using a UAV, and undergoes grayscale processing to obtain a farmland grayscale image. FIG. 2 is a schematic diagram of a farmland grayscale image according to an embodiment of the present disclosure. The grayscale processing for images is a well-known technique; thus, the specific method will not be detailed herein.

Since the acquired image may contain some level of noise, applying non-local means filtering for denoising to each pixel point in the image may be computationally expensive. The objective of the analysis is known to be the farmland. Therefore, only the distribution of pixel points within the farmland and the distribution of potential noise points need to be analyzed. Based on the distribution characteristics of the noise, the pixel points are filtered to obtain target pixel points that are more likely to be noise. Filtering and denoising is performed only on the target pixel points. Since there may be varying levels of noise among the target pixel blocks, different filtering weights need to be selected based on the varying noise levels, and the distribution of noise may also exhibit relative changes along a certain direction. Therefore, this embodiment adjusts the filtering weights based on extension directions of different edges, distances between different edges, and the varying representations of corresponding noise levels.

It is known that pixel points at different positions in an image have different levels of noise. If the noise is distributed within the farmland, due to the presence of certain color distributions and corresponding texture distributions within the farmland, noise pixel points and texture pixel points may overlap at locations of significant grayscale changes among local pixel points. If smoothing is directly applied to the pixel points within the farmland, it may blur the expression of the texture and color of the farmland. When noise points are located on the edges of the farmland, it may greatly affect the delineation of farmland areas and the assessment of corresponding growth conditions. Therefore, it is necessary to eliminate noise pixel points located on the edges of the farmland. Since the noise levels vary across different areas, inappropriate filtering weights may lead to poor filtering results. This embodiment first filters the pixel points to obtain target pixel points that are more likely to be noise.

A Canny edge detection algorithm is employed to detect edges in the farmland grayscale image, yielding a plurality of edge lines in the image. The Canny edge detection algorithm is a well-known technique; thus, the specific method will not be detailed herein.

In this embodiment, a preset quantity threshold is set to 3 for illustrative purposes. In other implementations, different values may be set; this embodiment does not impose limitations. The quantity threshold is used to evaluate the number of pixel points along the edge lines in the farmland grayscale image, and filtering the edge lines based on the quantity threshold helps avoid capturing isolated edge pixel points. It is understood that noise pixel points in the farmland grayscale image typically refer to isolated pixel points or small pixel blocks that have significantly different values from surrounding pixel values. Therefore, isolated noise pixel points are generally singular, and the quantity threshold is commonly small to prevent eliminating excessive edge lines, which could adversely impact subsequent operational decisions. In this embodiment, considering the potential for small areas containing noise pixel points, the preset quantity threshold is 3.

In the farmland grayscale image, the number of pixel points on each edge line is counted, and edge lines with a pixel point count greater than a preset threshold are designated as the main edge lines.

It should be noted that due to the presence of isolated noise points, when an edge line contains a small number of pixel points, these pixel points are highly likely to be noise points. Therefore, the quantity threshold is used to make a judgment, to eliminate some of influence of the noise on the edges.

Step S002: Obtain a noise probability of each pixel point based on grayscale value differences between pixel points in the farmland grayscale image and distances from the pixel points to the main edge lines; and select a plurality of target pixel points based on the noise probability of each pixel point.

An arbitrary pixel point in the farmland grayscale image is taken as a reference point.

A minimum distance from the reference point to each main edge line in the farmland grayscale image is calculated, and a minimum value among the minimum distances from the reference point to all the main edge lines is designated as an edge distance of the reference point. It should be noted that when the reference point is located on a main edge line, the edge distance of the reference point is 0.

In this embodiment, a preset window length is set to n₁=5 for illustrative purposes. In other implementations, different values may be set; this embodiment does not impose limitations.

In the farmland grayscale image, a window centered on the reference point with a size of n₁×n₁ is defined as a main window of the reference point.

The purpose of collecting the image is to analyze the planting conditions in the farmland. Therefore, it is necessary to analyze the characteristics of potential noise pixel points at different levels on the edges of and within the farmland. The closer a noise point is to the edge of the farmland, and the more abrupt the grayscale value changes at a pixel point, the more likely this point is to be noise.

In this embodiment, a preset constant β is set to 1 for illustrative purposes. In other implementations, different values may be set; this embodiment does not impose limitations.

Thus, the calculation formula for the noise probability M of the reference point can be as follows:

$$M = Norm ( \frac{1}{Z + β} \times \frac{{\sum }_{i = 1}^{m} \vert G - {G}_{i} \vert}{{G}_{avg}} )$$

where M denotes the noise probability of the reference point, Z denotes the edge distance of the reference point, G_{avg} denotes an average grayscale value of all pixel points in the main window of the reference point, G denotes a grayscale value of the reference point, Gᵢ denotes a grayscale value of the i-th pixel point in the main window of the reference point, m denotes the number of pixel points in the main window of the reference point, ∥ denotes an absolute value function, Norm( ) denotes a linear normalization function, normalizing data values within a range of [0, 1]. β denotes the preset constant.

It should be noted that:

$$\frac{{\sum }_{i = 1}^{m} \vert G - {G}_{i} \vert}{{G}_{avg}}$$

represents a grayscale difference between the reference point and other pixel points within the main window. A larger value indicates a greater grayscale difference within the main window of the reference point, and the reference point is more likely to be noise. Conversely, a smaller value of Z suggests that the reference point is closer to the edge, and has greater impact on the image quality. Therefore, a normalized value of the product of

$$\frac{1}{Z + β} and \frac{{\sum }_{i = 1}^{m} \vert G - {G}_{i} \vert}{{G}_{avg}}$$

is used to represent the noise probability of the reference point, where Z+β serves to prevent the denominator from being 0. A larger the value of M suggests that the reference point is more likely to be noise.

Following method described above, the noise probability of each pixel point in the farmland grayscale image is obtained.

It should be noted that, based on the foregoing calculation, the noise probabilities corresponding to the edge pixel points in the image are also relatively high. This is due to the fact that edges represent crucial information in an important image, and requires focused filtering and denoising.

In this embodiment, a preset noise threshold is set to 0.5 for illustrative purposes. In other implementations, different values may be set; this embodiment does not impose limitations. When the noise probability of a pixel point exceeds the noise threshold, it indicates that the pixel point is more likely to be noise. Conversely, when the noise probability of a pixel point is less than or equal to the noise threshold, it indicates that the pixel point is less likely to be noise. Since the noise probabilities for each pixel point are constrained within the range of [0, 1], the value of the noise threshold is set within the range of (0, 1). A noise threshold value closer to 1 indicates a more stringent criterion for determining whether a pixel point is noise, while a noise threshold value closer to 0 suggests a more lenient criterion for determining whether a pixel point is noise. In this embodiment, a relatively moderate value is chosen for evaluating whether a pixel point is noise.

In the farmland grayscale image, pixel points with a noise probability greater than the preset noise threshold are designated as the target pixel points. This results in a plurality of target pixel points within the farmland grayscale image. Filtering and denoising is performed only on the target pixel points, thereby reducing computational load.

Step S003: Take an arbitrary target pixel point in the farmland grayscale image as a target point, and obtain a plurality of neighborhood blocks corresponding to the target point; obtain a credibility of each neighborhood block corresponding to the target point based on all main edge lines in the neighborhood block, a connection line between the target point and the neighborhood block, and the noise probabilities of pixel points in the neighborhood block; and select a plurality of main neighborhood blocks corresponding to the target point based on the credibility of each neighborhood block corresponding to the target point.

An arbitrary target pixel point in the farmland grayscale image is taken as the target point.

In this embodiment, a search window length n₂=11 and a preset neighborhood window length n₃=3 are set for illustrative purposes. In other implementations, different values may be set; this embodiment does not impose limitations.

In the farmland grayscale image, calculation is performed on the target point based on the preset search window size and the preset neighborhood window size by using a non-local means filtering algorithm, to obtain a plurality of neighborhood blocks corresponding to the target point.

It should be noted that, the non-local means filtering algorithm is a well-known technique; thus, the specific method will not be detailed herein. The search window size and the neighborhood window size are the main parameters of this algorithm. The process of obtaining a plurality of neighborhood blocks corresponding to the target point involves constructing a search window with a size of n₂×n₂ centered on the target point, constructing a neighborhood window with a size of n₃×n₃ centered on the target point, and allowing the neighborhood window to slide within the search window to obtain a plurality of neighborhood blocks. This is a known technique. Neighborhood blocks in the non-local means filtering algorithm are also referred to as similar blocks or reference blocks.

Since different target pixel points can have varying levels of noise, the manifestation of different noise levels can differ in various directions and exhibit corresponding variations. Because farmlands are typically rectangular or trapezoidal, there is a certain similarity relation along the edges of the farmland, while noise is randomly distributed. Thus, lower consistency between the direction of noise in the search window and the direction of edges indicates a higher credibility of noise level, and the corresponding filtering degree should be higher. There are also differences in the sizes of farmlands; larger farmlands have edges that are farther apart, resulting in greater variation in the expression of noise levels.

The number of all pixel points on all the main edges within each neighborhood block corresponding to the target point are counted; and linear fitting is performed on all the pixel points on all the main edges using a least squares method, to obtain a fitting line for each neighborhood block corresponding to the target point. The fitting line reflects the edge direction of each neighborhood block corresponding to the target point.

A line that passes through the target point and a center point of each neighborhood block corresponding to the target point is denoted as a position line of each neighborhood block corresponding to the target point.

A minimum angle value between the fitting line and the position line of each neighborhood block corresponding to the target point is denoted as a degree of parallelism of each neighborhood block corresponding to the target point.

Thus, the calculation formula for the credibility of each neighborhood block corresponding to the target point is as follows:

$${F}_{j} = Norm ( ( 1 - {M}_{j}^{′} ) \times \frac{1}{β + {B}_{j}} ) , j = \{ 1 , 2 , … , t \}$$

where Fⱼ denotes the credibility of the j-th neighborhood block corresponding to the target point, t denotes the number of neighborhood blocks corresponding to the target point, Mⱼ′ denotes a mean of the noise probabilities of all pixel points in the j-th neighborhood block corresponding to the target point, Bⱼ denotes the degree of parallelism of the j-th neighborhood block corresponding to the target point, and Norm( ) denotes a linear normalization function, normalizing data values within a range of [0, 1]. β denotes the preset constant.

It should be noted that: a larger value of Mⱼ′ indicates that the noise interference is more severe in the j-th neighborhood block corresponding to the target point, suggesting that the j-th neighborhood block corresponding to the target point is less credible and should be assigned a smaller filtering weight. A smaller value of Bⱼ indicates that the target point is aligned with the edge direction in the j-th neighborhood block corresponding to the target point, suggesting that the j-th neighborhood block corresponding to the target point is more important and credible to the target point, and thus should be assigned a larger filtering weight. Therefore, a normalized value of the product of

$$1 - {M}_{j}^{′} and \frac{1}{β + {B}_{j}}$$

is used to represent the credibility of the j-th neighborhood block corresponding to the target point. Adding β to βⱼ prevents the denominator from being zero.

In this embodiment, a preset criterion threshold is set to 0.6 for illustrative purposes. In other implementations, different values may be set; this embodiment does not impose limitations. When the credibility of a neighborhood block corresponding to the target point is greater than the criterion threshold, it indicates a higher likelihood that the target point is more likely to be aligned with the edge direction in the neighborhood block corresponding to the target point, and thus the neighborhood block corresponding to the target point is more important for the target point. When the credibility of a neighborhood block corresponding to the target point is less than or equal to the criterion threshold, it suggests that the noise interference in the neighborhood block corresponding to the target point is more severe, indicating that the neighborhood block corresponding to the target point is less important for the target point. Since values of the credibility are normalized, values of the criterion threshold also fall within the range of (0, 1). A criterion threshold value closer to 1 indicates a stricter evaluation criterion for the neighborhood blocks corresponding to the target point, while a criterion threshold value closer to 0 suggests a more lenient evaluation criterion for the neighborhood blocks corresponding to the target point.

Among all the neighborhood blocks corresponding to the target point, neighborhood blocks with a credibility greater than the preset criterion threshold is designated as main neighborhood blocks corresponding to the target point.

It should be noted that the number of main neighborhood blocks corresponding to the target point is set to 3 or more for illustrative purposes. In other implementations, different values may be set; this embodiment does not impose limitations. If this condition is not met, the preset criterion threshold needs to be lowered to increase the number of neighborhood blocks corresponding to the target point.

Step S004: Obtain a filtering weight of each main neighborhood block corresponding to the target point based on all main edge lines in the main neighborhood block, the noise probabilities of pixel points in the main neighborhood block, the credibility of the main neighborhood block, as well as a distance and a connection line between the target point and the main neighborhood block.

This allows for an adaptive filtering weight for each main neighborhood block corresponding to the target point. Based on all main neighborhood blocks corresponding to the target point and the filtering weights thereof, an updated grayscale value after filtering and denoising for the target point is obtained.

Different regions of the farmland exhibit different orientations. For example, there may be significant variation in noise characteristics within neighborhood blocks located on the non-parallel edges of a trapezoidal farmland. However, for a trapezoidal farmland and its adjacent farmlands, neighborhood blocks and target points on their edges are closer in distance, leading to a certain similarity in noise characteristics of the neighborhood blocks. Moreover, different neighborhood blocks in the same direction may require adjustment of the filtering weights due to varying distances; for instance, neighborhood blocks on the two edges far apart of a rectangular farmland are located in different regions and exhibit greater differences in edge characteristics, necessitating adjustments in the respective filtering weights. For farmlands of different sizes, a higher degree of overlapping between edges of a larger farmland and a smaller farmland indicates more severe interference to the edge of the smaller farmland, and thus the filtering weight for the edge of the smaller farmland should be smaller. Additionally, edges of the farmland present linear characteristics.

Thus, a minimum angle value between the position lines of any two main neighborhood blocks corresponding to the target point is recorded as a position distribution value of the two main neighborhood blocks.

A mean of position distribution values of all the main neighborhood blocks corresponding to the target point is denoted as a characteristic value of the distribution of the main neighborhood blocks corresponding to the target point.

Thus, the calculation formula for the filtering weight of each main neighborhood block corresponding to the target point is as follows:

$${Q}_{x} = ( 1 - \frac{C}{90} ) \times \frac{{F}_{x}^{′} \times ( {H}_{x} + β )}{( {M}^{′} + {M}_{x}^{″} )} \times \frac{1}{{D}_{x}} , x = \{ 1 , 2 , … , y \}$$

where Qₓ denotes the filtering weight of the x-th main neighborhood block corresponding to the target point, C denotes a characteristic value of distribution of the main neighborhood blocks corresponding to the target point, Fₓ′ denotes the credibility of the x-th main neighborhood block corresponding to the target point, Hₓ denotes the number of pixel points on all main edge lines in the x-th main neighborhood block corresponding to the target point, M′ denotes the noise probability of the target point, Mₓ″ denotes a mean of the noise probabilities of all pixel points in the x-th main neighborhood block corresponding to the target point, Dₓ denotes a distance from the target point to a center point of the x-th main neighborhood block corresponding to the target point, and y denotes the number of main neighborhood blocks corresponding to the target point. β denotes the preset constant.

It should be noted that the selected target pixel points are likely to be either noise points or edge pixel points in the image. When C is smaller, it indicates that the target point is aligned with the center point of its main neighborhood block. Given the linear characteristics of the farmland edges, it is more likely that the target point and the center point of the main neighborhood block are located on the same edge of the farmland. Therefore, a larger filtering weight should be assigned. Since maximum C can be 90 degrees, C/90 is a normalized value of C. When there are more edge pixel points in the main neighborhood block, that is, Hₓ is larger, and when the credibility Fₓ′ of the main neighborhood block is higher, a larger filtering weight is required. When M′+Mₓ″ is larger, it indicates that the x-th main neighborhood block and the target point are more significantly affected by noise, and a smaller filtering weight is required. Thus,

$$( 1 - \frac{C}{90} ) \times \frac{{F}_{x}^{′} \times ( {H}_{x} + β )}{( {M}^{′} + {M}_{x}^{″} )}$$

is used to represent a weight adjustment value for the x-th main neighborhood block corresponding to the target point. The non-local means filtering algorithm assigns weights based on the distance from the target point to the neighborhood block; the smaller the distance, the larger the weight. Hₓ+β prevents Hₓ from being 0, which would impact the calculation of Qₓ. Therefore, the product of

$$( 1 - \frac{C}{90} ) \times \frac{{F}_{x}^{′} \times ( {H}_{x} + β )}{( {M}^{′} + {M}_{x}^{″} )} and \frac{1}{{D}_{x}}$$

is used to represent the filtering weight of the x-th main neighborhood block corresponding to the target point.

Step S005: Obtain an enhanced farmland image from the farmland grayscale image based on all main neighborhood blocks corresponding to all target pixel points in the farmland grayscale image and the filtering weights of all the main neighborhood blocks.

In the farmland grayscale image, the target point is filtered and denoised based on all the main neighborhood blocks corresponding to the target point and the filtering weights of all the main neighborhood blocks by using a non-local means filtering algorithm, to obtain an updated grayscale value of the target point.

It should be noted that, the non-local means filtering algorithm is a well-known technique; thus, the specific method will not be detailed herein. A process for obtaining the updated grayscale value of the target point involves performing a weighted average of grayscale values of pixel points within all main neighborhood blocks corresponding to the target point based on the filtering weights of all the main neighborhood blocks corresponding to the target point, resulting in the updated grayscale value of the target point.

Following method described above, the updated grayscale value of each target pixel point in the farmland grayscale image is obtained.

An image composed of updated grayscale values of all the target pixel points and grayscale values of all other pixel points except the target pixel points in the farmland grayscale image is designated as the farmland enhanced image corresponding to the farmland grayscale image. In this way, high-quality farmland enhanced images are used for analyzing agricultural planting conditions, successfully completing enhanced monitoring of agricultural planting. Thus, the present disclosure is complete.

In summary, in the embodiments of the present disclosure, a farmland grayscale image is obtained, from which a plurality of target pixel points are selected. Next, a plurality of neighborhood blocks corresponding to each target pixel point are obtained. Then, the credibility of each neighborhood block corresponding to the target pixel point is obtained, thereby selecting a plurality of main neighborhood blocks corresponding to the target pixel point. A filtering weight of each main neighborhood block corresponding to the target pixel point is obtained, thereby deriving a farmland enhanced image from the farmland grayscale image. In the embodiment of the present disclosure, main neighborhood blocks are selected from the neighborhood blocks corresponding to the target pixel points, and filtering weights of the main neighborhood blocks are adapted, to enhance the filtering and denoising effect, resulting in a high-quality farmland enhanced image, which ultimately enhances the monitoring effect for agricultural planting.

The above described are merely preferred embodiments of the present disclosure, and not intended to limit the present disclosure. Any modifications, equivalent replacements and improvements made within the spirit and principle of the present disclosure should all fall within the scope of protection of the present disclosure.

What is claimed is:

1. An enhanced monitoring method for agricultural planting based on unmanned aerial vehicle (UAV) remote sensing, comprising the following steps:
acquiring a farmland grayscale image of a farmland, wherein the farmland grayscale image contains a plurality of edge lines; and selecting a plurality of main edge lines from all the edge lines in the farmland grayscale image;
obtaining a noise probability of each pixel point based on grayscale value differences between pixel points in the farmland grayscale image and distances from the pixel points to the main edge lines; and selecting a plurality of target pixel points based on the noise probability of each pixel point;
taking an arbitrary target pixel point in the farmland grayscale image as a target point, and obtaining a plurality of neighborhood blocks corresponding to the target point; obtaining a credibility of each neighborhood block corresponding to the target point based on all main edge lines in the neighborhood block, a connection line between the target point and the neighborhood block, and the noise probabilities of pixel points in the neighborhood block; and selecting a plurality of main neighborhood blocks corresponding to the target point based on the credibility of each neighborhood block corresponding to the target point;
obtaining a filtering weight of each main neighborhood block corresponding to the target point based on all main edge lines in the main neighborhood block, the noise probabilities of pixel points in the main neighborhood block, the credibility of the main neighborhood block, as well as a distance and a connection line between the target point and the main neighborhood block; and
obtaining an enhanced farmland image from the farmland grayscale image based on all main neighborhood blocks corresponding to all target pixel points in the farmland grayscale image and the filtering weights of all the main neighborhood blocks.

2. The enhanced monitoring method for agricultural planting based on UAV remote sensing according to claim 1, wherein said selecting a plurality of main edge lines from all the edge lines in the farmland grayscale image specifically comprises:
counting the number of pixel points on each edge line in the farmland grayscale image, and designating edge lines with a pixel point count greater than a preset quantity threshold as the main edge lines.

3. The enhanced monitoring method for agricultural planting based on UAV remote sensing according to claim 1, wherein said obtaining the noise probability of each pixel point based on the grayscale value differences between the pixel points in the farmland grayscale image and the distances from the pixel points to the main edge lines specifically comprises:
taking an arbitrary pixel point in the farmland grayscale image as a reference point;
calculating a minimum distance from the reference point to each main edge line in the farmland grayscale image, and designating a minimum value among the minimum distances from the reference point to all the main edge lines as an edge distance of the reference point;
in the farmland grayscale image, defining a window centered on the reference point with a size of n₁×n₁ as a main window of the reference point, wherein n₁ is a preset window length; and
obtaining a noise probability of the reference point based on grayscale values of pixel points within the main window of the reference point and the edge distance of the reference point.

4. The enhanced monitoring method for agricultural planting based on UAV remote sensing according to claim 3, wherein a specific calculation formula for obtaining the noise probability of the reference point based on the grayscale values of the pixel points within the main window of the reference point and the edge distance of the reference point is as follows:
$$M = Norm ( \frac{1}{Z + β} \times \frac{{\sum }_{i = 1}^{m} \vert G - {G}_{i} \vert}{{G}_{avg}} )$$
wherein M denotes the noise probability of the reference point, Z denotes the edge distance of the reference point, G_{avg} denotes an average grayscale value of all pixel points in the main window of the reference point, G denotes a grayscale value of the reference point, Gᵢ denotes a grayscale value of the i-th pixel point in the main window of the reference point, m denotes the number of pixel points in the main window of the reference point, ∥ denotes an absolute value function, Norm( ) denotes a linear normalization function, and β denotes a preset constant.

5. The enhanced monitoring method for agricultural planting based on UAV remote sensing according to claim 1, wherein said selecting a plurality of target pixel points based on the noise probability of each pixel point specifically comprises:
in the farmland grayscale image, designating pixel points with a noise probability greater than a preset noise threshold as the target pixel points.

6. The enhanced monitoring method for agricultural planting based on UAV remote sensing according to claim 1, wherein said obtaining a plurality of neighborhood blocks corresponding to the target point specifically comprises:
in the farmland grayscale image, performing calculation on the target point based on a preset search window size and a preset neighborhood window size by using a non-local means filtering algorithm, to obtain the plurality of neighborhood blocks corresponding to the target point.

7. The enhanced monitoring method for agricultural planting based on UAV remote sensing according to claim 1, wherein said obtaining the credibility of each neighborhood block corresponding to the target point based on all the main edge lines in the neighborhood block, the connection line between the target point and the neighborhood block, and the noise probabilities of the pixel points in the neighborhood block specifically comprises:
counting the number of all pixel points on all the main edges within each neighborhood block corresponding to the target point; and performing linear fitting on all the pixel points on all the main edges using a least squares method, to obtain a fitting line for each neighborhood block corresponding to the target point;
denoting a line that passes through the target point and a center point of each neighborhood block corresponding to the target point as a position line of each neighborhood block corresponding to the target point;
recording a minimum angle value between the fitting line and the position line of each neighborhood block corresponding to the target point as a degree of parallelism of each neighborhood block corresponding to the target point; and
obtaining the credibility of each neighborhood block corresponding to the target point based on the degree of parallelism of each neighborhood block corresponding to the target point and the noise probabilities of all the pixel points within the neighborhood block, with a specific calculation formula as follows:
$${F}_{j} = Norm ( ( 1 - {M}_{j}^{′} ) \times \frac{1}{β + {B}_{j}} )$$
wherein Fⱼ denotes the credibility of the j-th neighborhood block corresponding to the target point, Mⱼ′ denotes a mean of the noise probabilities of all pixel points in the j-th neighborhood block corresponding to the target point, Bⱼ denotes the degree of parallelism of the j-th neighborhood block corresponding to the target point, Norm( ) denotes a linear normalization function, and β denotes a preset constant.

8. The enhanced monitoring method for agricultural planting based on UAV remote sensing according to claim 1, wherein said selecting a plurality of main neighborhood blocks corresponding to the target point based on the credibility of each neighborhood block corresponding to the target point specifically comprises:
among all the neighborhood blocks corresponding to the target point, designating neighborhood blocks with a credibility greater than a preset criterion threshold as the main neighborhood blocks corresponding to the target point.

9. The enhanced monitoring method for agricultural planting based on UAV remote sensing according to claim 7, wherein a specific calculation formula for obtaining the filtering weight of each main neighborhood block corresponding to the target point based on all the main edge lines in the main neighborhood block, the noise probabilities of the pixel points in the main neighborhood block, the credibility of the main neighborhood block, as well as the distance and the connection line between the target point and the main neighborhood block is as follows:
$${Q}_{x} = ( 1 - \frac{C}{90} ) \times \frac{{F}_{x}^{′} \times ( {H}_{x} + β )}{( {M}^{′} + {M}_{x}^{″} )} \times \frac{1}{{D}_{x}}$$
wherein Oₓ denotes the filtering weight of the x-th main neighborhood block corresponding to the target point, C denotes a characteristic value of distribution of the main neighborhood blocks corresponding to the target point, Fₓ′ denotes the credibility of the x-th main neighborhood block corresponding to the target point, Hₓ denotes the number of pixel points on all main edge lines in the x-th main neighborhood block corresponding to the target point, M′ denotes the noise probability of the target point, Mₓ″ denotes a mean of the noise probabilities of all pixel points in the x-th main neighborhood block corresponding to the target point, Dₓ denotes a distance from the target point to a center point of the x-th main neighborhood block corresponding to the target point, and β denotes a preset constant;
a process of obtaining the characteristic value of the distribution of the main neighborhood blocks corresponding to the target point comprises: denoting a minimum angle value between position lines of any two main neighborhood blocks corresponding to the target point as a position distribution value for said any two main neighborhood blocks; and
denoting a mean of position distribution values of all the main neighborhood blocks corresponding to the target point as the characteristic value of the distribution of the main neighborhood blocks corresponding to the target point.

10. The enhanced monitoring method for agricultural planting based on UAV remote sensing according to claim 1, wherein said obtaining the enhanced farmland image from the farmland grayscale image based on all the main neighborhood blocks corresponding to all the target pixel points in the farmland grayscale image and the filtering weights of all the main neighborhood blocks specifically comprises:
in the farmland grayscale image, filtering and denoising the target point based on all the main neighborhood blocks corresponding to the target point and the filtering weights of all the main neighborhood blocks by using a non-local means filtering algorithm, to obtain an updated grayscale value of the target point; and
designating an image composed of updated grayscale values of all the target pixel points and grayscale values of all other pixel points except the target pixel points in the farmland grayscale image as the farmland enhanced image corresponding to the farmland grayscale image.
